(19) United States
(12) Patent Application Publication
(10) Pub. No.: US 2018/0091515 A1
(43) Pub. Date: Mar. 29, 2018

(54) DISTRIBUTION OF CODE TO AN AUTHORIZED TARGET INFRASTRUCTURE

(71) Applicant: Hewlett Packard Enterprise Development LP, Houston, TX (US)

(72) Inventors: Sung Oh, Roseville, CA (US); Barry L. Goodwin, Roseville, CA (US)

(21) Appl. No.: 15/277,170

(22) Filed: Sep. 27, 2016

(51) Int. Cl. H04L 29/06

(52) U.S. Cl. CPC H04L 63/101; H04L 63/083

(57) ABSTRACT

Examples herein disclose a computer-readable medium, system, and method for distribution of code to an authorized target infrastructure within a manufacturing environment. Prior to deployment of the target infrastructure, receive a digital signature corresponding to the target infrastructure. In response to a determination that the target infrastructure is authorized to receive code via the digital signature, distribute code to the target infrastructure.

### BACKGROUND

In a manufacturing environment, components may be assembled or modified to create a manufactured infrastructure, such as a server, networking, and/or storage infrastructure. The manufactured infrastructure may be deployed directly to a consumer or deployed to another manufacturing environment for use in a different product.

### BRIEF DESCRIPTION OF THE DRAWINGS

In the accompanying drawings, like numerals refer to like components or blocks. The following detailed description references the drawings, wherein:

FIG. 1 is a block diagram of an example system including a master device to authorize a target infrastructure within a manufacturing environment to receive code in accordance with the present disclosure;

FIG. 2 is a block diagram of an example system including a master device to detect an unknown server attached to a server infrastructure within a manufacturing environment based on a digital signature corresponding to firmware implemented on a server and in response determine that the server infrastructure is unauthorized to receive code in accordance with the present disclosure;

FIG. 3 is a block diagram of an example system including a master device to detect an unknown switch attached to a network infrastructure and determine that the network infrastructure is unauthorized to receive code in accordance with the present disclosure;

FIG. 4 is a block diagram of an example system including a master device to detect an unknown storage module attached to a storage infrastructure based on a digital signature corresponding to storage modules within the storage infrastructure and proceed to identify the storage infrastructure as unauthorized to receive code in accordance with the present disclosure;

FIG. 5 is a flowchart of an example to identify whether a target infrastructure within a manufacturing environment is authorized or unauthorized to receive code in accordance with the present disclosure;

FIG. 6 is a block diagram of an example computing device with a processing resource to execute instructions in a machine-readable storage medium for distributing code to a target infrastructure in response to an authorization of the target infrastructure to receive code in accordance with the present disclosure; and

FIG. 7 is a block diagram of an example computing device with a processing resource to execute instructions in a machine-readable storage medium to in response to a determination that a target infrastructure is unauthorized, perform a detection process based on a type of infrastructure in accordance with the present disclosure.

### DETAILED DESCRIPTION

Prior to deploying the manufactured infrastructure, code may he distributed to the manufactured infrastructure. One approach sends the code directly to the manufactured infrastructure, while another approach sends the code to a factory server for distribution to the manufactured infrastructure. Both of these approaches may blindly distribute code to a manufactured infrastructure that may be unauthorized or comprised. Distributing code to these compromised infrastructures may cause security issues. For example, an unauthorized entity may be able to reverse engineer the distributed code with the purpose of maliciously comprising systems and infrastructures. Additionally, distributing code to a compromised infrastructure may cause operational and security issues when shipped to the consumer. The term “code” may be used herein to refer to a set of machine-readable instructions and may include, by way of example, test scripts, software, firmware, programs, diagnostics, instructions, and/or applications.

Accordingly, the present disclosure provides a mechanism to verify whether a manufactured infrastructure is authorized to receive a distribution of code through use of a digital signature. By verifying whether the manufactured infrastructure is authorized to receive the distribution of code, the present disclosure may identify whether the manufactured infrastructure has been compromised and proceed to implement proactive measures to safeguard the distribution of code to the compromised infrastructure. Additionally, identifying whether the manufactured infrastructure has been compromised prior to deployment adds a quality check to ensure the manufactured infrastructure remains uncompromised.

The present disclosure also manages the distribution of code to those manufactured infrastructures that are authorized. Managing the distribution of code prevents proprietary code from reaching unauthorized entities. The term “authorization” may be used herein to refer to those infrastructures which are considered uncompromised while the term “unauthorization” refers to those manufactured infrastructures are unknown and may be considered compromised.

The following detailed description refers to the accompanied figures. Wherever possible, the same reference numbers are used in the figures and the following description to refer to the same or similar parts. It is to be expressly understood, however, that the figures are for the purpose of illustration and description only. While several examples are described throughout, modification, adaptions, and other implementations are possible. Accordingly, the following detailed description is not meant to limit the disclosed examples, rather it is meant to provide proper scope of the disclosed examples and may be defined by the appended claims.

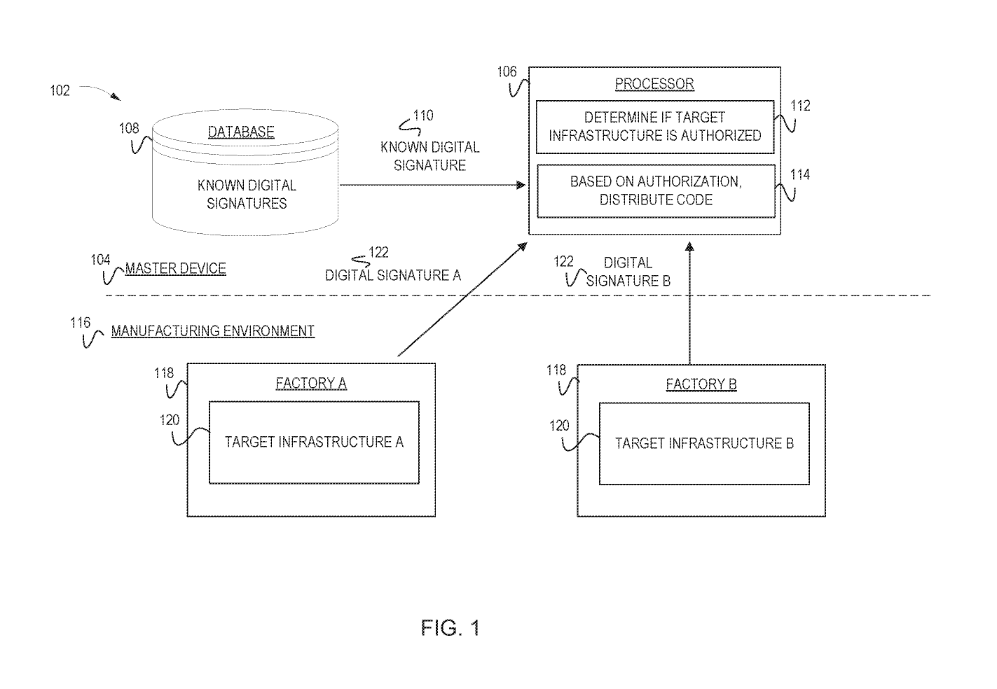

FIG. 1 illustrate an example system 102 including master device 104 to authorize target infrastructure 120 located in manufacturing environment 116. Master device 104 includes processor 106 and database 108 which work in conjunction to determine if target infrastructure 120 is authorized and in response, distribute code as at modules 112-114. System 102 represents master device 104 in communication with target infrastructure(s) 120 in manufacturing environment 116. Although system 102 illustrates master device 104 and manufacturing environment 116 as remotely connected, this was done for illustration purposes as master device 104 may be part of manufacturing environment 116.

Master device 104 is an electronic component which includes processor 106 and database 108. Prior to deployment of target infrastructure(s) 120, processor 106 receives digital signature(s) 122 corresponding to target infrastructure(s) 120. In one implementation, received digital signature(s) 112 correspond to the various components connected to create the respective target infrastructure while in another implementation, received digital signatures(s) 112 correspond to the respective complete target infrastructure(s) 120. In further implementations, master device 104 operates as a master server in remote communication with target infrastructure(s) 120. Operating in remote communications allows master device 104 to be located in a wholly separate location from manufacturing environment 116. Implementations of master device 104 include, by way of example, a server, a computing device, a networking device, a data center, a virtual server, a virtual networking component, or other type of device which manages distribution of code to authorized target infrastructure(s).

Processor 106, in communication with database 108, obtains known digital signature 110 and manufacturing environment 116 and receives digital signature(s) 122. Based on receiving these digital signature(s) 110 and 122, processor 106 determines if target infrastructure(s) 120 are authorized to receive code from master device 104 at module 112. In response to the determination that the target infrastructure(s) 120 are authorized, processor 106 proceeds to distribute code to the authorized target infrastructure(s) as at module 114. In response to the determination that the target infrastructure(s) are unauthorized, processor 106 does not distribute code. This implementation may be discussed in later figures. Implementations of processor include, by way of example, a central processing unit (CPU), integrated circuit, controller, semiconductor, processing resource, or other type of hardware component capable of the functionality of the processor 106.

Database 108 is a storage area as part of master device 104 which includes a list of known digital signatures. The list of known digital signatures are a list of tiles (e.g., hash files, hash values) that correspond to known or authorized infrastructures which are considered uncompromised and safe to receive code from master device 104. Implementations of database 108 include, by way of example, a storage array, a memory, a cache, a Random Access Memory (RAM), an Electrically Erasable Programmable Read-Only Memory (EEPROM), a storage drive, a memory cache, network storage, virtual storage, etc.

Known digital signature 110 represents an infrastructure with connected components that is known or previously authorized. The authorized infrastructure includes the components which has been granted permission to receive code. If any of the component(s) connected to the target infrastructure(s) 120 or the target infrastructure(s) have not been given permission to receive code, this indicates that target infrastructure is unauthorized and may include an unknown component. In one implementation, known digital signature 110 represents an encrypted character or string of encrypted characters that master device 104 may decrypt to verify the authorization of the target infrastructure(s) 120. In another implementation, known digital signature 10 includes a message-digest has function, such as MD2, MD4, and MD5, and Secure Hash Algorithm (SHA) to hash known digital signature 110 into a shorter value or longer value. As such, implementations the digital signature and known digital signature include a bitstring, hash value, hash code, hash sum, value, character, string of characters, or other type of representation to authorize target infrastructure(s) 120 for receiving code. The format of known digital signature and digital signature(s) 122 are similar to one another, such that processor 106 uses these as inputs to identify whether target infrastructure(s) 120 are authorized to receive code from master device 104.

At modules 112-114, processor 106 identifies if target infrastructure(s) 120 are authorized and in response, processor 106 distributes code to the authorized target infrastructure(s) 120. Although digital signature(s) 122 include two signatures, this was done for illustration purposes as processor 106 may receive a single digital signature corresponding to one of target infrastructure(s) 120. At module 112, processor 106 compares known digital signature 110 to digital signature(s) 122. In the case of a discrepancy (e.g., difference) between known digital signature 110 and digital signature(s) 122, this indicates target infrastructure(s) 120 are unauthorized to receive code. In the case of a correspondence (e.g., similarity) between known digital signature 110 and digital signature(s) 122, this indicates target infrastructure(s) 120 are known and authorized to receive code from master device 104. At module 114, in response that target infrastructure(s) 122 are authorized, processor 106 proceed to distribute code to the authorized target infrastructures. Implementations of modules 112-114 include, by way of example, instructions (e.g., stored on a machine-readable medium) that, when executed (e.g., by processor 106), implement the functionality of modules 112-114. Alternatively, or in addition, the modules 112-114 may include electronic circuitry (i.e., hardware) that implements the functionality of modules 112-114.

Manufacturing environment 116 may include factories 118 that may assemble or modify components attached to respective target infrastructure(s) 120 prior to deployment to a consumer or other manufacturing environment. Factories 118 represent locations of target infrastructure(s) 120 prior to deployment. Although FIG. 1 illustrates factories 118 as separate from manufacturing environment 116, this was done for illustration purposes as the term “manufacturing environment” is used as a broad term to describe at least a single location where target infrastructure(s) 120 are located prior to deployment to a customer or another factory. Additionally, FIG. 1 illustrates two separate factories 118 (Factory A, Factory B), this was done for illustration purposes as there may be a single factory (Factory A or Factory B).

Target infrastructure(s) 120 represents a physical structure which may be fabricated, modified, and/or updated within factories 118 in manufacturing environment 116. Target infrastructure(s) 120 are located within manufacturing environment prior to deployment. These target infrastructure(s) 120 may include at least one or combination of a server infrastructure, a storage infrastructure, and/or a network infrastructure. Each of these infrastructures represent a different type of infrastructure. As such, if one of these infrastructures are determined to be unauthorized to receive code from master device 104, a detection process is performed to identify the unauthorized or unknown component connected to the infrastructure. The process is dependent on the type of infrastructure as explained in later figures.

Target infrastructure(s) 120 include corresponding digital signature(s) 122 for processor 106 to identify the authorization. As such, digital signature(s) 122 represent a mathematical function to demonstrate the authenticity of authorization of target infrastructure(s) 120. Digital signature(s) 112 may be collected by processor 106 prior to deployment of target infrastructure(s) 120. In one specific implementation, digital signature(s) 122 are hashed files representing the components or complete target infrastructure(s) 120. As explained earlier, the format of digital signature(s) 122 are similar to known digital signature 110. This may include, by way of example, the same number of characters, the same hashing function, etc.

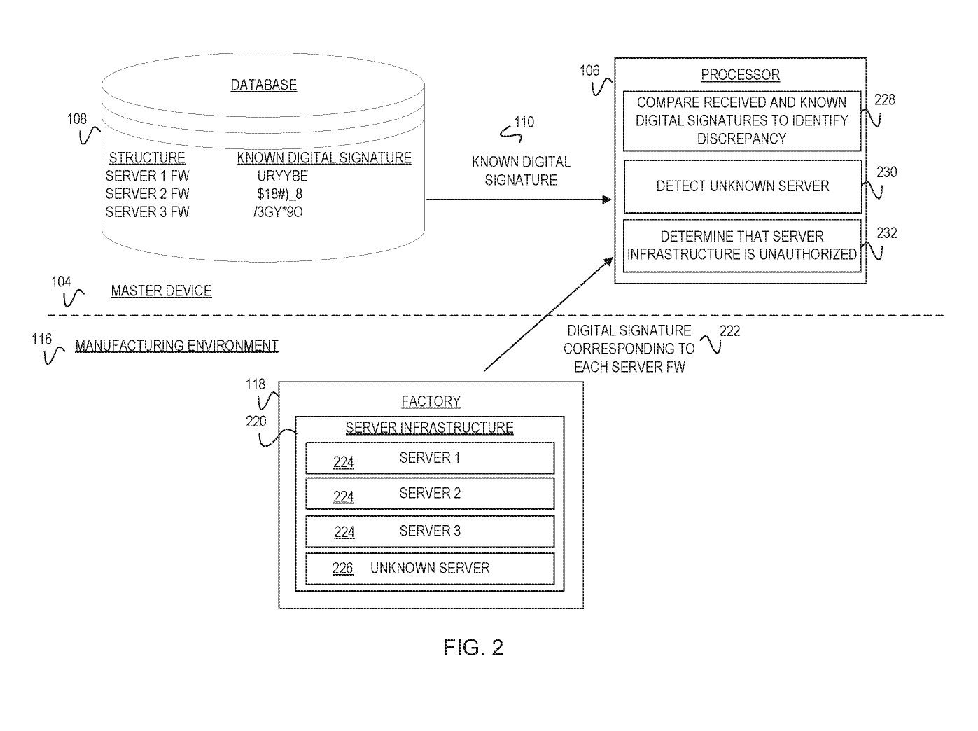

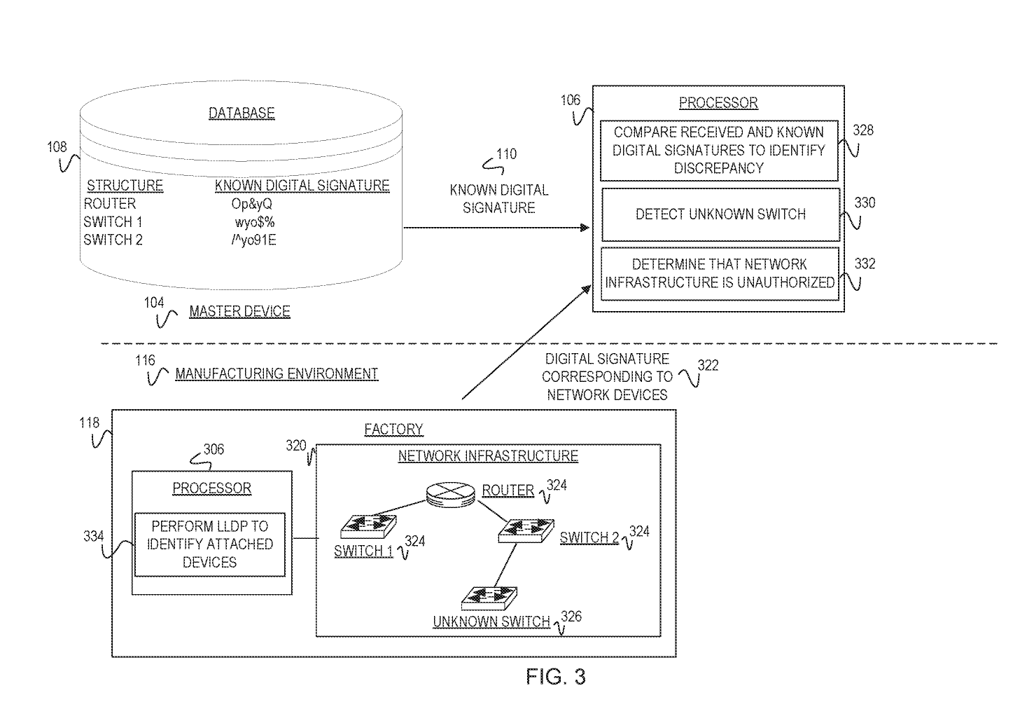

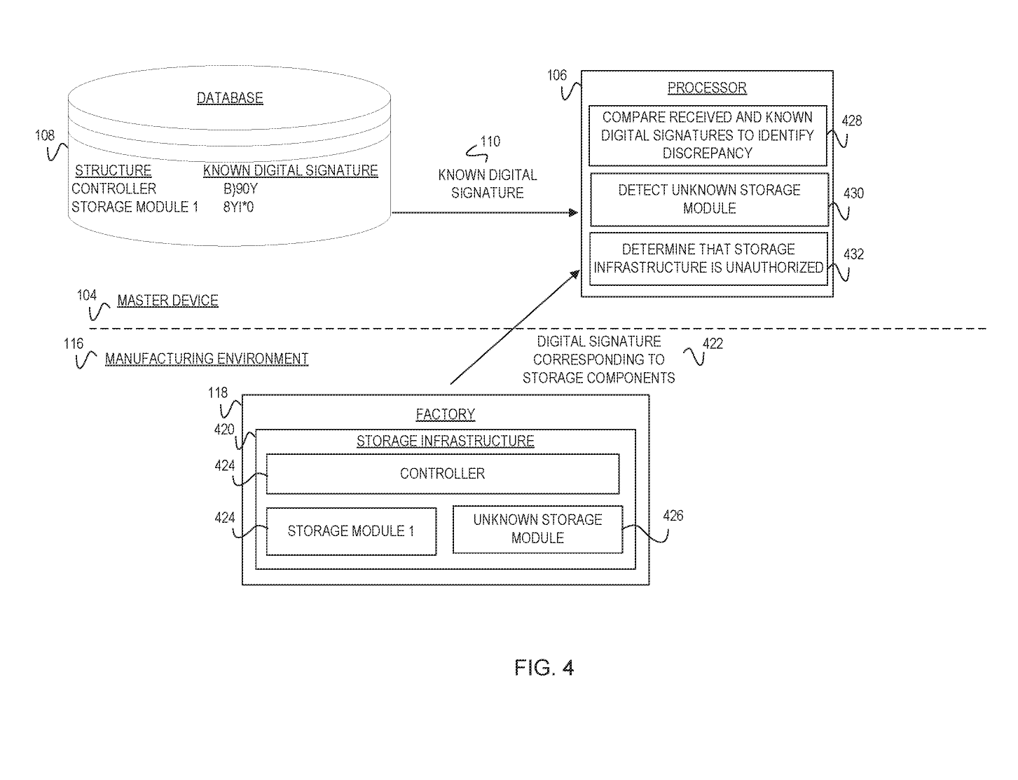

FIGS. 2-4 each illustrate a block diagram of an example system including a different type of target infrastructure. For example, FIG. 2 illustrates a server infrastructure, FIG. 3 illustrates a network infrastructure, and FIG. 4 illustrates a storage infrastructure. Depending on the type of target infrastructure, each figure may take a different approach to detect an unknown device.

FIG. 2 is a block diagram of an example system including master device 104 to detect unknown server 226 as part of server infrastructure 220 in manufacturing environment 116. Digital signature 222 corresponds to firmware implemented at each server 224 and unknown server 226. Based on a comparison between this digital signature 222 and known digital signature 110 at module 228, processor 106 may detect unknown server 226 at module 230. As such, firmware implemented at servers 224 is used to track and identify unknown server 226. In response to the detection of unknown server 226, processor 106 determines that server infrastructure 220 is unauthorized to receive code at module 232. FIG. 2 represents the situation of where a type of target infrastructure includes server infrastructure 220 and process to detect unknown server 226 to identify server infrastructure 220 as unauthorized.

Database 108 lists example hash values of firmware implemented at known servers 224 (Server 1, Server 2, Server 3). In this example, the list of example known digital signatures (e.g., hash values) are used in comparison to a list of digital signatures 222 corresponding for firmware implemented at servers 224 as part of server infrastructure 220.

Digital signature 222 that corresponds to firmware implemented at server infrastructure 220. Specifically, digital signature 222 may include a single hash value corresponding to the overall server infrastructure 220 or multiple hash values corresponding to firmware implemented at each known server 224 (Server 1, Server 2, Server 3). In one implementation, digital signature 222 includes a hash file of the hash value representing the overall server infrastructure with servers 224 and unknown server 226 combined. In other implementations, digital signature 222 includes a hash file with hash values each corresponding to the different servers 224 and unknown server 226. In this latter implementation, a scanning process using a server's console is performed to identify the firmware corresponding to each server 224 and 226. The hash values representing each server firmware is placed in a server table to transmittal to processor 106. In this case, the server table contains known servers 224 (Server 1, Server 2, Server 3) except for unknown server 226 which may not have a hash value against that device 226. This process allows processor 106 to detect unknown server 226 and notify operations staff for further action without releasing or distributing code.

Servers 224 and unknown server 226 represent a different server which are configured as part of server infrastructure 220. Servers 224 represent known servers to master device 104, while unknown server 226 represents that server which may not have been previously authorized. Alternatively, unknown server 226 may represent that server which may have been relocated form one server infrastructure to server infrastructure 220. This may alert processor 106 to this unapproved transition from one infrastructure to another which allows master device 104 to identify server infrastructure 220 as unauthorized.

FIG. 3 is a block diagram of an example system including master device 104 to detect an unknown networking component (e.g., switch 326) attached to network infrastructure 320 via known digital signature(s) 110 and digital signature(s) 322. Digital signature 322 corresponds to network devices 324 and 326 which are attached to network infrastructure 320. In response to comparing both known digital signature(s) 110 and digital signature(s) 322, processor 106 determines that network infrastructure 320 is unauthorized to receive code. Processor 106 works in conjunction with database 108 to obtain known digital signature(s) 110 corresponding to previously known networking components 324 (Router, Switch 1, Switch 2). Obtaining the known digital signature(s) 110, processor 106 proceeds to compare to received digital signature 322 at module to detect unknown switch 326 at modules 328-330. Detecting unknown switch 326, allows master device 104 to identify changes to network infrastructure 320 and/or modification of network topology. Changes to network infrastructure 320 may include removal, additional, and/or replacement a networking component, while modification of network topology may include moving a location of the networking component within the network infrastructure 320. In this example, a set of network devices attached to one network infrastructure moved to a different network infrastructure from which processor 106 may be able to detect this modification. In this sense, master device 104 may identify unknown devices and also detect changes on network configurations. This may be achieved via link layer discover protocol (LLDP) during a discovery phase to identify attached networking devices 324 and 326.

Prior to deployment of network infrastructure 320, processor 306 performs a scanning process via LLDP to identify networking devices 324 and 326 attached to network infrastructure 324 at module 334. Alternatively, these network devices 324 and 326 may be detected with an active network port. Based on the identification of networking devices 324 and 326, digital signature 322 is composed as list of previously known networking devices 324 (Switch 1, Switch 2, Router) and active ports, except unknown switch 236 which does not have a hash file. Processor 106 compares this digital signature 322 to known digital signatures 110 from database 108 to identify a discrepancy between the hash values at module 328. In response to identified discrepancy, processor 106 detects unknown switch 326 which was excluded as the hash file from digital signature 322. Based on the detection of unknown switch 320, processor 106 proceeds to determine that network infrastructure is unauthorized at module 332.

FIG. 4 is a block diagram of an example system including master device 104 to detect unknown storage module 426 as part of storage infrastructure 420 via known digital signatures) 110 and digital signature(s) 422. Digital signature(s) 422 correspond to known storage components 424 (Controller and Storage Module 1). Upon receiving digital signature(s) 422 and obtaining known digital signature(s) 110, processor 106 compares these digital signatures 110 and 422 to identify if a discrepancy exists at module 428. Upon determining the existence of the discrepancy between digital signatures 110 and 422, processor 106 detects unknown storage module 426 at module 430. In response to detecting unknown storage module 426, processor 106 proceeds to determine that storage infrastructure 420 is unauthorized to receive code.

Prior to deployment of storage infrastructure 420, storage controller 424 performs a scanning process to identify attached storage modules 424 and 426. In this case, digital signature 422 contains previously known storage components (Controller and Storage Module 1) 424 except for unknown storage module 426. Unknown storage module 426 does not contain a hash tile. Receiving digital signature 422, processor 106 identifies unknown storage module 426 as unauthorized since the digital signature 422 did not include hash value corresponding to this module 426.

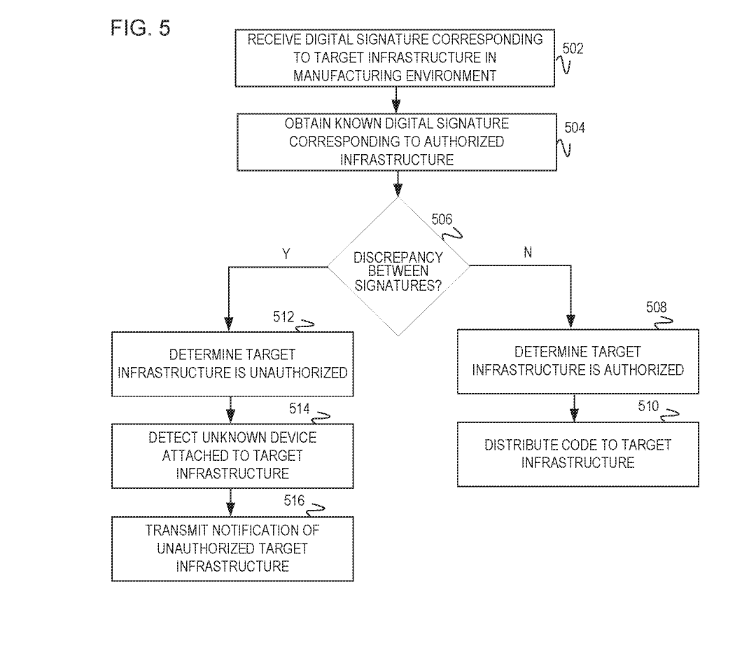

FIG. 5 is an example flowchart as illustrated in accordance with various examples of the present disclosure. The flowchart represents a process that may be utilized in conjunction with various systems and devices as discussed with reference to the preceding figures. While illustrated in a particular order, the flowchart is not intended to be so limited. Rather, it is expressly contemplated that various processes may occur in different orders and/or simultaneously with other processes than those illustrated.

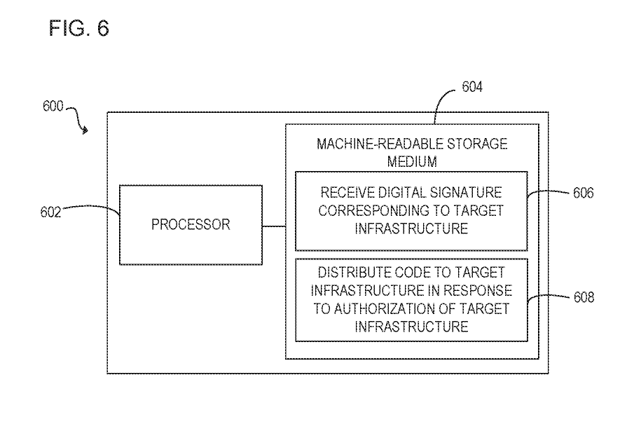

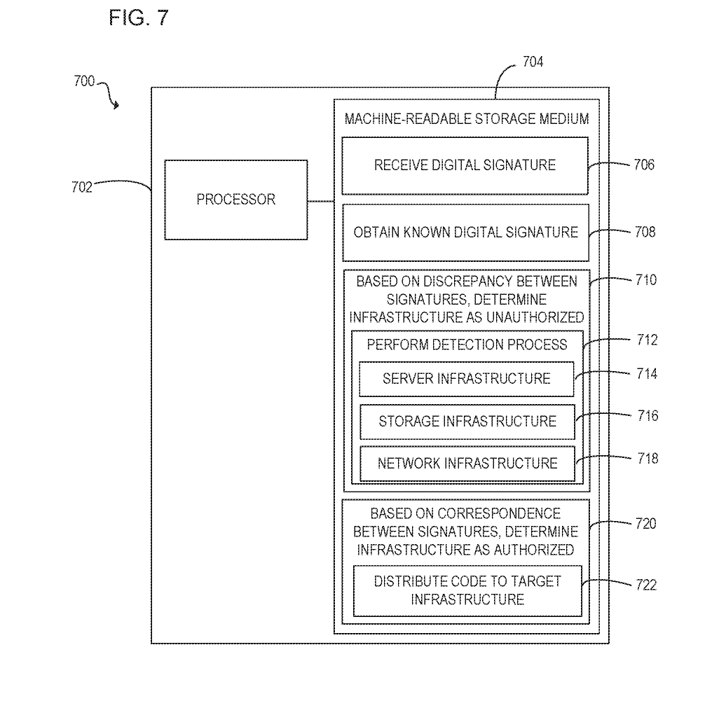

FIG. 5 illustrates the example method to authorize or unauthorize a target infrastructure within a manufacturing environment. In response to the authorization of the target infrastructure, a computing device distributes code. In response to the unauthorization of the target infrastructure, the computing devices detect an unknown device connected to the target infrastructure without distribution of code. The method is executable by the computing device, to identify the authorization of unauthorization. Prior to deployment of the target infrastructure, the computing device receives a digital signature which corresponds to the target infrastructure and may proceed to obtain a known digital signature which corresponds to a known authorized infrastructure. Using these digital signatures, the computing device may identify a correlation (e.g., equivalence) between the signatures. Upon identifying the correlation, the computing device determines that the target infrastructure is authorized to receive code and proceeds to distribute code to the target infrastructure. Alternately, the computing device may identify a discrepancy (e.g., difference) between these digital signatures and proceeds to determine that the target infrastructure is unauthorized, in response to determination that the target infrastructure is unauthorized, the computing device proceeds to detect an unknown source connected to the target infrastructure that may be the source of the unathorization. In addition, the computing device may transmit a notification of the unauthorization. In discussing FIG. 5, references may be made to the components in FIGS. 1-4 to provide contextual examples. For example, master device 104 including processor 106 and/or database 108 works in conjunction to execute operations 502-516 to distribute code in response to an authorization of the target infrastructure or detect an unknown device in response to an unauthorization of the target infrastructure. Although FIG. 5 is described as implemented by the computing device, it may be executable on other suitable hardware components. For example, FIG. 5 may be implemented in the form of executable instructions on a machine-readable storage medium 604 and 704 as in FIGS. 6-7.

At operation 502, the computing device receives the digital signature corresponding to the target infrastructure. The computing device may transmit a request or query to the target infrastructure to receive the digital signature. The received digital signature represents an encrypted character or string of encrypted characters that the computing device may decrypt to verify the authorization of the target infrastructure. In this sense, the received digital signature corresponds to the components and devices which provide the composition of the target infrastructure. The computing device may proceed to obtain the known digital signature from a storage to identify an existence of the discrepancy.

At operation 504, the computing device obtains the known digital signature from the database. The known digital signature represents those components and/or devices which provide the framework of a known and authorized infrastructure. The known digital signatures may be predefined as those infrastructure components that are known to be uncompromised. In one implementation, the known digital signature may be received prior to receiving the digital signature corresponding to the target infrastructure.

At operation 506, the computing device proceeds to compare the received digital signature corresponding to the target infrastructure to the known digital signature corresponding to the known authorized infrastructure. In one implementation, operations 502-504 may be performed in combination to verify that the target infrastructure is authorized to receive code via the received digital signature and the known digital signature. Upon comparing the digital signatures, the computing proceeds to identify if the target infrastructure is authorized or unauthorized to receive code. In response to the discrepancy between the digital signatures, the computing device determines that the target infrastructure is unauthorized and proceeds to operations 512-516. In response to the correlation (e.g., similarity) between the digital signatures, the computing device determines that the target infrastructure is authorized and proceeds to operations 508-510.

At operations 508-510, in response to a correspondence (e.g., similarity) between the digital signature and a known digital signature, the computing device determines that the target infrastructure is authorized to receive code. Based on the authorization, the computing device proceeds to operation 510 to distribute code.

At operation 512, based on the computing device determining there is the discrepancy (e.g., difference) between the received digital signature and the known digital signature as at operation 506, the computing device determines that the target infrastructure is unauthorized to receive code. In an implementation, the discrepancy in both the received digital signature and the known digital signature, also allows the computing device to identify an unknown component or unknown device that is attached to the target infrastructure as at operation 514. As such, in this implementation, operations 506 and 512-514 may occur in combination or simultaneously together.

At operation 514, a computing device located within the manufacturing environment performs a scanning process via LLDP for discovering the components or devices attached to the target infrastructure. Based on the LLDP, the computing devices identities the unknown component or unknown device attached to the target infrastructure. In implementations the approach to detect the unknown device is dependent on the type of target infrastructure as seen in connection with earlier figures.

At operation 516, in response that the target infrastructure is unauthorized to receive code, the computing device transmits a notification of the unauthorization without distributing code to the unauthorized target infrastructure. In a further implementation, the notification may include the identity of the unknown device for an operations staff to perform the appropriate diagnostics and corrective actions, accordingly.

Referring now to FIGS. 6-7, example block diagrams of computing devices 600 and 700 to execute instructions 606-608 and 706-722 are illustrated in accordance with various examples of the present disclosure. The instructions represent machine-readable operations that may be utilized in conjunction with various systems and devices as discussed with reference to the preceding figures. While illustrated in a particular order, these instructions 606-608 and 706-722 are not intended to be so limited. Rather, it is expressly contemplated that instructions may be executed in different orders and/or simultaneously with other instructions than those illustrated.

FIG. 6 is a block diagram of computing device 600 with a processor 602 to execute instructions 606-608 within a machine-readable storage medium 604. Although the computing device 600 includes processing resource 602 and machine-readable storage medium 604, it may also include other components that would be suitable to one skilled in the art. For example, the computing device 600 may include a controller, memory storage, or other suitable type of component. The computing device 600 is an electronic device with the processing resource 602 capable of executing instructions 606-608 and as such embodiments of the computing device 600 include a networking device, server, mobile device, desktop computer, or other type of electronic device capable of executing instructions 606-608. The instructions 606-608 may be implemented as methods, functions, operations, and other processes implemented as machine-readable instructions stored on the storage medium 604, which may be non-transitory, such as hardware storage devices (e.g., random access memory (RAM), read only memory (ROM), erasable programmable ROM, electrically erasable ROM, hard drives, and flash memory).

The processing resource 602 may fetch, decode, and execute instructions 606-608 to distribute code to an authorized target infrastructure. Specifically, the processing resource 602 executes instructions 606-608 to: receive a digital signature corresponding to a target infrastructure within a manufacturing environment; determine that the target infrastructure is authorized to receive code based on the received digital signature; and in response to the determination that the target infrastructure is authorized to receive code, distribute code to the target infrastructure.

The machine-readable storage medium 604 includes instructions 606-608 for the processing resource 602 to fetch, decode, and execute. In another embodiment, the machine-readable storage medium 604 may be an electronic, magnetic, optical, memory, storage, flash-drive, or other physical device that contains or stores executable instructions. Thus, the machine-readable storage medium 604 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 604 may include an application and/or firmware which can be utilized independently and/or in conjunction with the processing resource 602 to fetch, decode, and/or execute instructions of the machine-readable storage medium 604. The application and/or firmware may be stored on the machine-readable storage medium 604 and/or stored on another location of the computing device 600.

FIG. 7 is a block diagram of computing device 700 with a processing resource 702 to execute instructions 706-722 within a machine-readable storage medium 704. Specifically, the computing device 700 with the processing resource 702 identify whether a target infrastructure is authorized or unauthorized to receive code. In response to a determination that the target infrastructure is authorized to receive code, distribute code to the target infrastructure. In response to a determination that the infrastructure is unauthorized to receive code, perform a detection process to identify an unknown device attached to the target infrastructure. Although the computing device 700 includes processing resource 702 and machine-readable storage medium 704, it may also include other components that would be suitable to one skilled in the art. For example, the computing device 700 may include a controller, memory storage, or other suitable type of component. The computing device 700 is an electronic device with the processing resource 702 capable of executing instructions 706-722 and as such embodiments of the computing device 700 include a networking device, server, switch, router, mobile device, desktop computer, laptop, or other type of electronic device capable of executing instructions 706-722. The instructions 706-722 may be implemented as methods, functions, operations, and other processes implemented as machine-readable instructions stored on the storage medium 704, which may be non-transitory, such as hardware storage devices (e.g., random access memory (RAM), read only memory (ROM), erasable programmable ROM, electrically erasable ROM, hard drives, and flash memory),

The processing resource 702 may fetch, decode, and execute instructions 706-722 to determine whether a target infrastructure within a manufacturing environment is authorized or unauthorized. Specifically, the processing resource 702 executes instructions 706-722 to: prior to deployment of a target infrastructure, receive a digital signature corresponding to the target infrastructure; obtain a known digital signature corresponding to an authorized infrastructure; compare both signatures; in response to a discrepancy between the signatures, identify the target infrastructure as unauthorized; perform a detection process to identify an unknown component attached to the target infrastructure, the detection process is dependent on a type of the target infrastructure (i.e., server infrastructure, storage infrastructure, network infrastructure); in the case that the target infrastructure includes the server infrastructure, the received digital signature corresponds to the firmware implemented at each server connected to the infrastructure to identify an unknown server connected to the infrastructure; in the case that the target infrastructure includes a storage infrastructure, the received digital signature corresponds to the attached storage controller(s) and attached storage module(s) while the known digital signature includes the known or authorized storage controller(s) and storage module(s) so that the unknown or unauthorized storage controller(s) and storage module(s) are identified; in the case that the target infrastructure includes a network infrastructure, a link layer discovery protocol (LLDP) is performed on the network infrastructure, so that the received digital signature includes all attached network devices and the known digital signature includes all known and authorized network devices such that a comparison between these signatures identifies the unknown network device; and in response to a correspondence (e.g., similarity) between the digital signatures, determine the target infrastructure is authorized to receive code and distribute code to the target infrastructure within the manufacturing environment.

The machine-readable storage medium 704 includes instructions 706-722 for the processing resource 702 to fetch, decode, and execute. In another embodiment, the machine-readable storage medium 704 may be an electronic, magnetic, optical, memory, storage, flash-drive, or other physical device that contains or stores executable instructions. Thus, the machine-readable storage medium 704 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 704 may include an application and/or firmware which can be utilized independently and/or in conjunction with the processing resource 702 to fetch, decode, and/or execute instructions of the machine-readable storage medium 704. The application and/or firmware may be stored on the machine-readable storage medium 704 and/or stored on another location of the computing device 700.

Although certain embodiments have been illustrated and described herein, it will be greatly appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a variety of ways. This application is intended to cover adaptions or variations of the embodiments discussed herein. Therefore, it is manifestly intended that embodiments be limited only by the claims and equivalents thereof.

We claim:

1. A non-transitory machine-readable storage medium comprising instructions that when executed by a processing resource cause a computing device to:
prior to deployment of a target infrastructure, receive a digital signature corresponding to the target infrastructure within a manufacturing environment;
in response to a determination that the target infrastructure is authorized to receive code via the digital signature, distribute code to the target infrastructure within the manufacturing environment.

2. The non-transitory machine-readable storage medium of claim 1 comprising instructions that when executed by the processing resource cause the computing device to:
obtain a known digital signature of the target infrastructure within the manufacturing environment;
based on a discrepancy between the known digital signature and the digital signature, determine that the target infrastructure is unauthorized to receive code;
based on a correspondence between the known digital signature and the digital signature, determine that the target infrastructure is authorized to receive code.

3. The non-transitory machine-readable storage medium of claim 2 comprising instructions that when executed by the processing resource cause the computing device to:
in response to the determination that the target infrastructure is unauthorized to receive code, perform a detection process to identify an unknown device attached to the target infrastructure, the detection process is dependent on a type of the target infrastructure.

4. The non-transitory machine-readable storage medium of claim 3 wherein the type of target infrastructure includes at least one of: a server infrastructure, a storage infrastructure, and a network infrastructure.

5. A system to authorize a targeted infrastructure within a manufacturing environment to receive a distribution of code, the system comprising:
a master device, including a processor, to:
obtain a known digital signature from a database;
prior to deployment of a target infrastructure, determine whether the target infrastructure within the manufacturing environment is authorized to receive code via the known digital signature; and
in response to the determination that target infrastructure is authorized to receive code, distribute code to the target infrastructure.

6. The system of claim 5 comprising:
the database of known digital signatures corresponding to authorized target infrastructures, the database to provide the known digital signature to the master device.

7. The system of claim 5 wherein the target infrastructure includes a network infrastructure and wherein to determine whether the network infrastructure is authorized to receive code via the known digital signature, the master device is to:
identify devices attached to the network infrastructure via a link layer discovery protocol;
receive a digital signature corresponding to the devices; and
in response to a discrepancy between the digital signature and the known digital signature, determine that the network infrastructure is unauthorized to receive code; and
detect an unknown device among the devices attached to the network infrastructure.

8. The system of claim 5 wherein the target infrastructure includes a server infrastructure and wherein to determine whether the server infrastructure is authorized to receive code via the known digital signature, the master device is to:
receive a digital signature corresponding to firmware implemented in the server infrastructure;
based on a discrepancy between the digital signature and the known digital signature, determine that the server infrastructure is unauthorized to receive code.

9. The system of claim 9 wherein the target infrastructure includes a storage infrastructure and wherein to determine whether the storage infrastructure is authorized to receive code via the known digital signature, the master device is to:
receive a digital signature corresponding to storage devices attached to the storage infrastructure;
based on a discrepancy between the received digital signature and the known digital signature, determine that the storage infrastructure is unauthorized to receive code; and
detect an unknown storage device among the storage devices attached to the storage infrastructure.

10. A method, executable by a computing device, the method comprising:
prior to deployment of a target infrastructure, verifying via a digital signature that the target infrastructure located in a manufacturing environment is authorized to receive code; and
in response to the verification that the target infrastructure is authorized, distributing code to the target infrastructure.

11. The method of claim 10 wherein verifying via the digital signature that the target infrastructure located in the manufacturing environment is authorized to receive code comprises:
receiving, from the manufacturing environment, the digital signature corresponding to the target infrastructure;
in response to a similarity between the digital signature and a known digital signature, authorizing the target infrastructure to receive code.

12. The method of claim 11 comprising:
in response to discrepancy between the digital signature and the known digital signature, identifying the target infrastructure as unauthorized to receive code.

13. The method of claim 10 comprising:
in response that the target infrastructure is unauthorized to receive code, transmitting notification of the unauthorization without distributing code to the target infrastructure.

14. The method of claim 10 comprising:
in response that the target infrastructure is unauthorized to receive code, performing a link layer discovery protocol;
based on the link layer discovery protocol, identifying an unauthorized network device within the target infrastructure.

15. The method of claim 10 comprising:
in response that the target infrastructure is unauthorized to receive code, detecting an unauthorized device within the target infrastructure.
